(19) United States
(12) Patent Application Publication
(10) Pub. No.: US 2010/0164471 A1
(43) Pub. Date: Jul. 1, 2010

(54) CALIBRATION OF PROGRAMMABLE I/O COMPONENTS USING A VIRTUAL VARIABLE EXTERNAL RESISTOR

(75) Inventor: Jean Barbier, Montpellier (FR)

Correspondence Address: SCHWABE, WILLIAMSON & WYATT, P.C., 1420 FIFTH, SUITE 3400, SEATTLE, WA, 98101-4010, US

(73) Assignee: M2000, Bievre (FR)

(21) Appl. No.: 12/346,650

(22) Filed: Dec. 30, 2008

(51) Int. Cl. G05B 24/02

(52) U.S. Cl. 323/353

(57) ABSTRACT

Embodiments provide systems, methods, and integrated circuits having a calibration structure with a calibration component and a measurement structure coupled to the calibration component. The measurement structure is configured to vary a current through the calibration component until a voltage of the calibration component equals an operation voltage. The variable current is a function of at least the operation voltage and a resistance of a resistor external to the measurement structure.

### TECHNICAL FIELD

Embodiments relate to the field of electronic circuits. In particular to the calibration of programmable input/output pad components at an operating voltage using an external reference resistor.

### BACKGROUND

Programmable input/output (I/O) interfaces are programmed to be compatible with various I/O protocols. To accomplish this, the programmable I/O pad components (such as resistors and transistors) are calibrated. Implementations use exact replicas of the programmable I/O pad, an external resistor, and a fixed voltage to measure the effective resistance of the pad at the fixed voltage. The external resistor is used because the resistor is sufficiently divorced from the device's presently-occurring operating conditions, and therefore remains stable enough to provide a reliable reference.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 illustrates a measurement structure and an input/output calibration structure in accordance with various embodiments;

FIG. 2 illustrates a system having a calibration structure, a measurement structure, configuration logic, a programmable input/output pad, and an external resistor according to various embodiments;

FIG. 3 illustrates a more detailed view of a measurement structure and a calibration structure in accordance with various embodiments; and

FIG. 4 illustrates extrapolating programmable input/output pad configuration parameters and programming input/output pad components according to various embodiments.

### DETAILED DESCRIPTION OF EMBODIMENTS

In the following detailed description, reference is made to the accompanying drawings which form a part hereof, and in which are shown by way of illustration embodiments in which the invention may be practiced. It is to be understood that other embodiments may be utilized and structural or logical changes may be made without departing from the scope of the disclosure. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent. Also, embodiments may have fewer operations than described. A description of multiple discrete operations should not be construed to imply that all operations are necessary. Also, embodiments may have fewer operations than described. A description of multiple discrete operations should not be construed to imply that all operations are necessary.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” means A or B. For the purposes of the description, a phrase in the form “A and/or B” means “(A), (B), or (A and B)”. For the purposes of the description, a phrase in the form “at least one of A, B, and C” means “(A), (B), (C), (A and B), (A and C), (B and C), or (A, B and C)”. For the purposes of the description, a phrase in the form “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments, are synonymous.

In various embodiments, methods, apparatuses, and systems for calibrating programmable input/output (I/O) pad components using a calibration component—separate from the I/O pad components—a desired operational voltage, and an external reference resistance are provided. Known approaches to calibrating programmable I/O pads include using an external resistor and a fixed voltage along with an exact replica of the I/O pad being configured. Problems with these approaches arise because many I/O pads include transistors, and a transistor's effective resistance is substantially non-linear as a function of operating voltage. Thus, measuring the effective resistance at a fixed operating voltage is not always sufficiently accurate when the desired operating voltage of the I/O pad is different from the fixed voltage. Also, using an entire replica of the I/O pad results in additional complexity and cost.

Embodiments may vary a current through a calibration component modeling an I/O pad component. The current is referenced to an external reference resistor having a stable resistance, the desired operating voltage, and a variable multiplication factor. Embodiments determine when a voltage across the calibration component equals the desired operating voltage, and extrapolates at least one I/O pad configuration parameter from at least the multiplication factor that causes the model component voltage to equal the desired operating voltage. Embodiments may use the multiplication factor to determine an effective resistance across the calibration component at the desired operating voltage, and use that effective resistance to extrapolate the I/O pad configuration parameters.

In embodiments, the calibration components may be near or exact replicas of the I/O pad components for which configuration parameters are extrapolated. In other embodiments, some or all of the calibration components may have different properties from the I/O pad components, but may have sufficient similar operating characteristics as the I/O pad components such that configuration parameters can be extrapolated, even though an effective resistance across the calibration component at the desired operating voltage may be different from the effective resistance across the I/O pad components at the desired operating voltage.

In embodiments, the calibration components may be subject to the same operating conditions as are the programmable I/O pads. That way, determining the effective resistance across calibration components may provide useful information as to the appropriate configuration parameters of the programmable I/O pad. Maintaining an external reference resistor may provide a stable reference resistance such that the programmable I/O pad can be accurately configured to have a resistance according to the desired configuration of the programmable I/O pads.

FIG. 1 illustrates a measurement structure and a calibration structure in accordance with various embodiments. Measurement structure 101 may comprise variable current generator 111, comparison circuit 113, and desired voltage 115 coupled to both comparison circuit 113 and variable current generator 111. A voltage generator, a digital-to-analog converter (DAC), or other device may be configured to generate desired voltage 115. In embodiments, such devices may be a component within measurement structure 101. Variable current generator 111 may be configured to accept voltage 115 and a multiplication factor as inputs and may be configured to be operatively coupled to an external reference resistor Rₑₓₜ. Variable current generator 111 may be configured to generate a variable current based on the desired operation voltage, Rₑₓₜ, and the multiplication factor.

Calibration structure 103 may comprise one or more calibration components 121 operatively coupled to variable current generator 111 and to comparison circuit 113. In embodiments, calibration component 121 may be a PMOS transistor, a NMOS transistor, a resistor, or other component. Measurement structure 101 may be configured to vary the variable current through calibration component 121, as it receives incrementally larger or smaller multiplication factor inputs. Comparison circuit may be configured to compare the voltage across calibration component 121 to desired operating voltage 115 and to produce a comparison signal indicating which is larger. In this way, measurement structure 103 may effectively generate a virtually-variable stable resistor for use to compare with the effective resistance of calibration component 121 at the desired operating voltage 115.

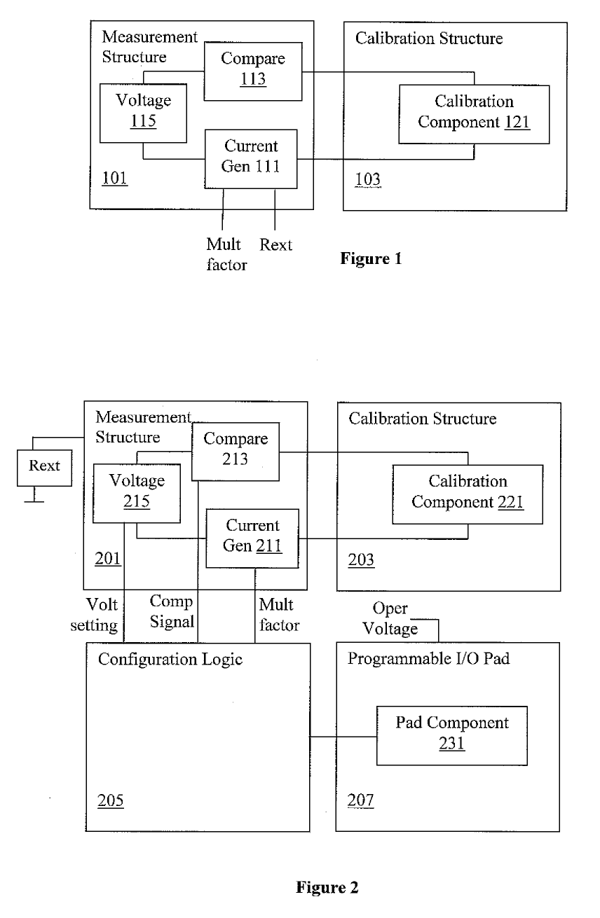

FIG. 2 illustrates a system having a calibration structure, a measurement structure, configuration logic, a programmable input/output pad, and an external resistor according to various embodiments. Calibration structure 203 may include one or more calibration components 221. Measurement structure 201 may include variable current generator 211, comparison circuit 213, and desired operating voltage 215 as described above. Configuration logic 205 may be operatively coupled to measurement structure 201 and to programmable input/output (I/O) pad 207. Configuration logic 205 may be configured to vary the multiplication factor input into variable current generator 211. In embodiments, the multiplication factor input may be a digital input. Configuration logic 205 may be configured to incrementally increase or decrease the multiplication factor. In other embodiments, configuration logic 205 may be configured to vary the multiplication factor in a non-incremental fashion. Configuration logic 205 may be configured to set desired operating voltage 215. In embodiments, configuration logic 205 may be configured to output a digital output to a DAC (either internal or external to measurement structure 201) to set operating voltage 215.

Variable current generator 211 may be configured to generate a variable current through calibration component 221, based on desired operating voltage 215, the multiplication factor, and external reference resistor Rₑₓₜ. Comparison circuit 213 may be configured to generate the comparison signal indicating one or more of whether the voltage across calibration component 221 is greater-than, less-than, greater-than-or-equal-to, or less-than-or-equal to desired operating voltage 215.

Configuration logic 205 may be configured to receive a comparison signal from comparison circuit 213. Configuration logic 205 may be configured to determine a multiplication factor that causes a state change in the comparison signal. Configuration logic 205 may be configured to extrapolate, from this determined multiplication factor, one or more configuration parameters for programming programmable I/O pad 207 and/or I/O pad component 231.

In embodiments, measurement structure 201, calibration structure 203, configuration logic 205, and programmable I/O pad 207 may all be included within a single integrated circuit. External reference resistor Rₑₓₜ may be an external resistor, sufficiently shielded from the current operating conditions of calibration structure 203 and programmable I/O pad 207.

In embodiments, the layouts of calibration components 221 in calibration structure 203 may be carefully controlled during manufacture such that their operating characteristics closely match pad component 231 in I/O pad 207. Thus, knowledge of their effective resistances at desired operating voltage 215 may be useful to determine the operating characteristics of the I/O pad components at the same voltage. In embodiments, calibration components may be the same as pad component 231. In other embodiments, it may be a scaled version of pad component 231. In embodiments, several I/O pads may share the same calibration components. This may be effective, for example, where several I/O pads are in a bank sharing a single supply voltage. In such cases, the local process variations may be small. In embodiments, calibration components 221 may be smaller in scale than I/O pad component 231. The configuration logic may then use simple calculations to determine the effective resistance of I/O pad components 231 from the effective resistance of calibration components 221.

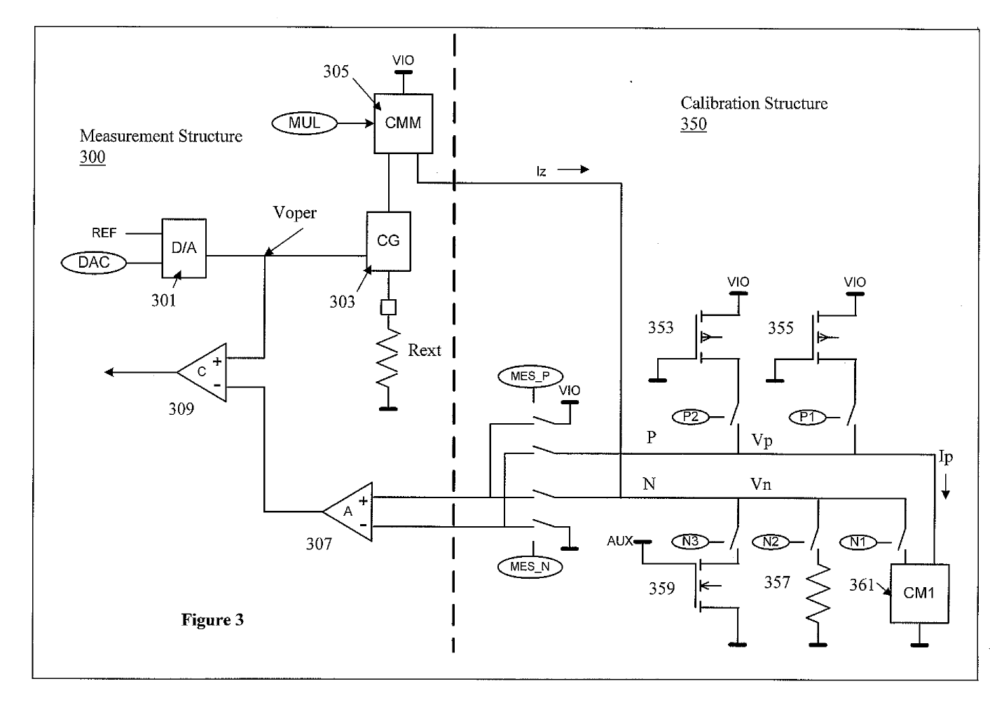

FIG. 3 illustrates details of measurement structure 300 and calibration structure 350 in accordance with various embodiments. Digital-to-Analog converter 301 may be configured to accept a digital input “DAC”, along with a reference voltage, to produce a desired operation voltage Vₒₚₑᵣ. Current generator 303 may be configured to accept Vₒₚₑᵣ as an input. Current generator 303 may also be configured to be operatively coupled to an external reference resistor Rₑₓₜ. Current generator 303 may be configured to generate a first current, determined by Vₒₚₑᵣ and Rₑₓₜ. Multiplying Current Mirror 305 may be configured to accept a multiplication factor input (“MUL”) and generate a variable current I_{z} based on the first current and the multiplication factor.

Calibration structure 350 may include one or more calibration components such as PMOS transistors 353 and 355, NMOS transistor 355, and resistor 357. In embodiments, more or fewer calibration components may be included. A series of pass transistor switches (having with calibration control points N1, N2, N3, P1, and P2) may be operable to selectively couple one of these calibration components to differential amplifier 307. MES_P switches may be operable to couple the PMOS transistors to the negative (“−”) terminal of differential amplifier 307, as well as to couple voltage VIO to the positive (“+”) terminal of amplifier 307. MES_N switches may be operable to couple NMOS transistor 359 and/or resistor 357 to the positive terminal of amplifier 307, and the negative terminal of amplifier 307 to ground.

To measure the effective resistance of the PMOS transistors, configuration logic (not shown) may be configured to activate the MES_P switches, switch N1, and one of P1 or P2, depending on which PMOS transistor's effective resistance is needed. Enabling switch N1 may activate current mirror 361. Current mirror 361 may be configured to duplicate variable current I_{z} through one of PMOS transistors 353 or 355 as current Iₚ. Current Iₚ through one of PMOS transistors 353 or 355 may generate a voltage Vₚ on wire segment P. Amplifier 307 may be configured to determine an absolute difference between the negative terminal voltage and the positive terminal voltage. Thus, by selectively coupling wire segment P to the negative terminal and the positive terminal to voltage VIO, amplifier 307 may output a voltage equal to the voltage across one of PMOS transistors 353 or 355.

Similarly, activating switches MES_N and switch N3 may couple wire segment N to the positive terminal of amplifier 307 and the negative terminal to ground. Thus, current I_{z} may be driven through NMOS transistor 359, and generate voltage Vₙ on wire segment N. Amplifier 307 may output a voltage equal to the voltage across NMOS transistor 359, which may also be equal to voltage Vₙ on wire segment N. Activating switch N2 instead of N3 may couple configuration resistor 357 to the positive terminal of amplifier 307 to determine the voltage across configuration resistor 357.

Comparator 309 may be configured to compare voltage Vₒₚₑᵣ to the output of amplifier 307 and to produce a signal indicating whether the voltage across one of the configuration components is greater than (or less than) Vₒₚₑᵣ. In embodiments, differential amplifier 307 may reliably reproduce the voltages of wire segment N and/or wire segment P to an input of comparator 309.

Configuration logic (not shown) may be coupled to the output of comparator 309 and may be configured to vary multiplication factor MUL in an incremental fashion—or other fashion—until the output of comparator 309 changes from one state to another. The configuration logic may be configured to determine configuration parameters for a programmable I/O pad (not shown) based on the value of MUL that causes the output of comparator 309 to change from one state to another. For example, the value of the external reference resistance Rₑₓₜ may be known, as are Vₒₚₑᵣ and the value of MUL that causes the output of comparator 309 to change. An effective resistance across one of the configuration components may be determined using these values. In embodiments, the configuration logic may be configured to determine the effective resistance across one of the configuration components as a function of Rₑₓₜ and MUL. Configuration parameter values may be determined based on this effective resistance. In other embodiments, lookup tables may be used to determine the configuration parameter values based on the determined value of MUL that causes the effective voltage across the configuration component to equal desired operational voltage Vₒₚₑᵣ, without calculating the effective resistance.

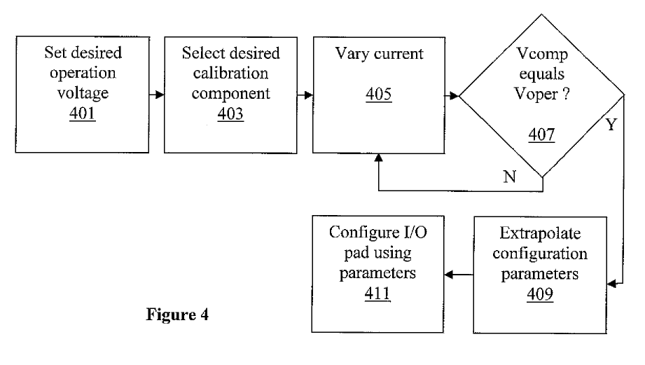

FIG. 4 illustrates extrapolating programmable input/output pad configuration parameters and programming input/output pad components according to various embodiments. First a desired operating voltage may be set block 401. Next, a calibration component may be selected for measurement block 403. A current through the calibration component may be varied based on a multiplication factor block 405. Once the voltage across the calibration component may be determined, block 407, to be equal—or nearly equal—to the desired operational voltage, the current that causes the voltages to be equal is determined (such as, for example, by determining the multiplication factor that causes the voltages to be equal) and configuration parameters for an I/O pad may be extrapolated block 409. Once extrapolated, one or more I/O pad components may be configured using the configuration parameters block 411.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the disclosure. Those with skill in the art will readily appreciate that embodiments of the disclosure may be implemented in a very wide variety of ways. This application is intended to cover any adaptations or variations of the embodiments discussed herein. Therefore, it is manifestly intended that embodiments of the disclosure be limited only by the claims and the equivalents thereof.

What is claimed is:

1. A system comprising:
a calibration structure comprising a calibration component; and
a measurement structure coupled to the calibration component, the measurement structure configured to vary a variable current through the calibration component until a voltage of the calibration component equals an operation voltage, the variable current being a function of at least the operation voltage and a resistance of a resistor external to the measurement structure.

2. The system of claim 1, wherein the variable current is further a function of a variable multiplication factor.

3. The system of claim 2, further comprising a programmable input/output (I/O) pad and configuration logic configured to extrapolate one or more programmable I/O pad configuration parameters for the programmable I/O pad from at least a determined particular value of the variable multiplication factor that causes the calibration component voltage to equal the operation voltage.

4. The system of claim 3, wherein the measurement structure further comprises a comparator coupled to the calibration structure and configured to compare the current operation voltage to the calibration component voltage and to produce a compare signal indicating which of the two voltages is greater.

5. The system of claim 4, wherein the configuration logic is configured to vary the multiplication factor and to determine the particular value of the multiplication factor by reference to a change in the compare signal.

6. The system of claim 3, wherein the configuration logic is configured to program the programmable I/O pad using at least the one or more extrapolated programmable I/O pad parameters.

7. The system of claim 3, wherein the calibration component is a same type as a I/O pad component of the programmable I/O pad.

8. The system of claim 1, wherein the calibration structure further comprises another calibration component, different from the calibration component, the calibration structure configured to selectively couple the calibration component and the other calibration component to the measurement structure.

9. The system of claim 1, further comprising the external resistor.

10. The system of claim 1, wherein the measurement structure comprises:
a digital-to-analog converter (DAC) configured to accept a first digital input to produce the operation voltage;
a current generator, coupled to the external resistor and to the DAC and configured to produce an initial current as a function of the resistance and the operation voltage; and
a current multiplier, coupled to the current generator and to the calibration component, and configured to receive a multiplication factor as a second digital input and to produce the variable current as a function of the initial current and the multiplication factor.

11. The system of claim 1, wherein the calibration component is a transistor or a resistor.

12. A method comprising:
setting a desired operating voltage in a measurement structure, the desired operating voltage equivalent to an operational voltage of a programmable input/output (I/O) pad; and
varying a current through a calibration component of a calibration structure, different from the programmable I/O pad, until a voltage across the model component equals the desired operating voltage, the current a function of an external resistor having a stable resistance and the desired operating voltage.

13. The method of claim 12, wherein the current is a function of a multiplication factor and wherein the varying the current comprises varying the multiplication factor.

14. The method of claim 13, comprising extrapolating, by configuration logic, at least one I/O pad configuration parameter from at least the multiplication factor that causes the calibration component voltage to equal the desired operating voltage.

15. The method of claim 14, further comprising programming, by the configuration logic, the programmable I/O pad using at least the one or more extrapolated programmable I/O pad parameters.

16. The method of claim 12, further comprising receiving, by the measurement structure, a first digital input indicative of the desired operating voltage, and a second digital input indicative of the multiplication factor.

17. The method of claim 16, further comprising receiving, by the configuration logic, a signal indicating whether the voltage across the calibration component is greater than or less than the desired operating voltage and incrementally increasing, by the configuration logic, the second digital input until the signal changes from one state to another.

18. An integrated circuit comprising:
a calibration structure comprising one or more calibration components; and
a measurement structure operatively coupled to the calibration structure, the measurement structure configured to vary a variable current through the calibration component until a voltage of the calibration component equals a desired operation voltage, the variable current being a function of at least the desired operation voltage and a resistance of a resistor external to the integrated circuit.

19. The integrated circuit of claim 18, wherein the variable current is a function of a variable multiplication factor.

20. The integrated circuit of claim 19, further comprising configuration logic configured to extrapolate one or more programmable input/output (I/O) pad configuration parameters from at least a determined particular value of the variable multiplication factor that causes the calibration component voltage to equal the operation voltage.

21. The integrated circuit of claim 20, wherein the measurement structure further comprises a comparator coupled to the calibration structure and configured to compare the current operation voltage to the calibration component voltage and to produce a compare signal indicating which of the two voltages is greater.

22. The integrated circuit of claim 21, further comprising a differential amplifier coupled between the comparator and the measurement structure, to reliably reproduce the calibration component voltage onto an input of the comparator.

23. The integrated circuit of claim 21, wherein the configuration logic is configured to vary the multiplication factor and to determine the particular value of the multiplication factor by reference to a change in the compare signal.

24. The integrated circuit of claim 20, further comprising a programmable I/O pad having an I/O pad component, and wherein the configuration logic is configured to program the programmable I/O pad component using at least the one or more extrapolated programmable I/O pad parameters.

25. The integrated circuit of claim 20, wherein the calibration component is a same type as the I/O pad component.

26. The integrated circuit of claim 18, wherein the calibration structure further comprises another calibration component, different from the calibration component, the calibration structure configured to selectively couple the calibration component and the other calibration component to the measurement structure.
